(19) United States
(12) Patent Application Publication
(10) Pub. No.: US 2008/0276065 A1
(43) Pub. Date: Nov. 6, 2008

(54) METHOD OF PARTITIONING STORAGE AREA OF RECORDING MEDIUM AND RECORDING MEDIUM USING THE METHOD, AND METHOD OF ACCESSING RECORDING MEDIUM AND RECORDING DEVICE USING THE METHOD

(75) Inventor: Seong-hun JEONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/032,177

(22) Filed: Feb. 15, 2008

(30) Foreign Application Priority Data
May 3, 2007 (KR) 10-2007-0043030

(51) Int. Cl. G06F 12/00

(52) U.S. Cl. 711/173; 711/E12.084

(57) ABSTRACT

Provided is a method of partitioning a storage area of a recording medium and a recording medium using the method, and a method of accessing a recording medium and a recording device using the method, capable of storing partition information used for partitioning a predetermined storage area included in the recording medium into a number of storage sub-areas in a first storage sub-area of the recording medium, and storing authority information which indicates whether an access instruction for accessing one of the partitioned storage sub-areas has authority to access the storage sub-area in a second storage sub-area. Accordingly, on a user's point, a read-only memory (ROM) area and a random access memory (RAM) area may be simultaneously provided to a NAND flash memory. On a content provider's point, desired contents are prevented from being deleted, and an additional space for storing added contents can be guaranteed.

### CROSS-REFERENCE TO RELATED PATENT APPLICATION

This application claims benefit from Korean Patent Application No. 10-2007-0043030, filed on May 3, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to a recording medium and partitioning a storage area of the recording medium, and accessing a recording medium and using a recording device in accessing a recording medium, and more particularly, to partitioning a storage area of a NAND flash memory and a method of accessing a NAND flash.

2. Description of the Related Art

There are increasing cases of storing contents in a storage device based on a NAND flash memory and distributing the contents. When the cost of the NAND flash memory decreases in the future, it is expected that the storage device based on the NAND flash memory would be used as a medium for distributing various contents. As an example of using the NAND flash memory, a kiosk or the like is used as a content download service to record desired contents in the NAND flash memory. Here, the kiosk refers to an information transfer system involving a touch screen installed in public places. For example, there is a movie download service of portoMedia. For another example, movies or music titles using a read-only memory (ROM) type storage medium such as a Blu-ray disc (BD), a digital versatile disc (DVD), a high-definition DVD (HD-DVD), and a compact disc (CD) can be manufactured as compact package content titles by replacing the storage medium with a compact NAND flash memory card. For another example, as a replacement for a conventional CD media for distributing company or product advertisement contents, the NAND flash memory can be used to distribute various advertisement contents (such as video, music, images, and texts).

FIG. 1 is a conceptual diagram showing various contents stored in a conventional NAND flash memory.

Various contents can be stored in the conventional NAND flash memory. The contents may include contents purchased by a user, information generated by a player, added contents provided by a content provider, added contents shared by another user and provided from a user community, and contents directly generated by a user. A device for storing various contents by using the NAND flash memory is referred to as package contents media. The contents purchased by the user are contents stored when the user purchases the NAND flash memory. An example of the information generated by the player includes a bookmark.

FIGS. 2a and 2b are conceptual diagrams showing a method of restricting recording authority in a general NAND flash memory.

Referring to FIG. 2a, in general, a memory card using the NAND flash memory provides a write protect switch, and when the write protect switch is enabled, recording in the entire memory is restricted. Referring to FIG. 2b, a flash memory chip provides a write protect pin (WP pin), and when the WP pin is enabled, recording in the entire chip is restricted. Therefore, it is impossible for the memory card using the NAND flash memory or the NAND flash memory chip to protect recording in partitioned storage sub-areas. For a NAND flash memory using a number of NAND flash memory chips, the number of chips is limited, so that partitioning the storage area into storage sub-areas is difficult. Even in a case where high-speed input/output is supported by using interleaving between chips, since address areas are distributed to a number of chips, it is difficult to partition the storage area.

The method of restricting the recording authority for the NAND flash memory can be performed by a file system existing in a host. However, the file system may not have a function of restricting memory recording authority, or otherwise, the user generally selects the restriction of the recording authority. Therefore, it is difficult for a content provider to restrict the recording authority of the user for the storage area of the memory. In addition, although the content provider patches the file system so that the user cannot change a setting used for restricting the recording authority, since the file system is a software executed in a host, the file system can be easily patched by a cracker. Therefore, in the method of restricting the recording authority using the conventional file system, canceling the setting used for restricting the recording authority according to intentions of a user is not difficult.

Traditionally, when a content provider wants to provide additional contents after distributing contents and has an area for recording the provided contents, the help of software is needed because obtaining a storage area at a hardware level is difficult,. When help of software is provided, patching and cracking the file system becomes possible.

In summary, when the recording authority is restricted in the hardware level according to the prior art, a method of restricting the recording authority in units of a memory card or a flash memory chip is used. However, there was a problem in that it is difficult to restrict the recording authority according to partitioned areas and allocate a dedicated storage area for the content provider. When the recording authority is restricted at a software level, since the file system of the host is used, there are problems in that cracking is possible according to intentions of a user, and releasing a setting used for restricting the recording authority is easy. In conclusion, according to the related art, when the content provider wants to restrict deleting and recording contents by a user, which are stored in a NAND flash memory and sold by the content provider, there is only the method of restricting recording in the entire NAND flash memory, so that there is a problem in that application of the NAND flash memory by the user is inconvenient.

### SUMMARY OF THE INVENTION

The present invention provides a method of partitioning a storage area of a recording medium and a recording medium using the method, and a method of accessing a recording medium and a recording device using the method, capable of preventing contents stored in a recording medium for distributing contents from being deleted by a person without authority, and providing a function of allocating a dedicated area for storing information additionally provided by a content provider.

According to an aspect of the present invention, there is provided a recording medium comprising: a storage area including a number of storage sub-areas; the number of storage sub-areas including at least a first storage sub-area, a second storage sub-area, and a third storage sub-area; the first storage sub-area storing partition information used for partitioning the storage area into the number of storage sub-areas; the second storage sub-area storing authority information which indicates whether a sub-area access instruction for accessing one of the storage sub-areas has authority to access the storage sub-area; and the third storage sub-area storing contents.

According to another aspect of the present invention, there is provided a recording device comprising: a recording medium storing authority information which indicates whether an access instruction for accessing a partitioned storage sub-area has authority to access the partitioned storage sub-area; an instruction controller determining whether the access instruction has authority to access the partitioned storage sub-area on the basis of the authority information stored in the recording medium and outputting a control signal when the access instruction has the authority to access according to a result of the determination; and a data controller controlling the recording medium upon receiving the control signal from the instruction controller.

According to another aspect of the present invention, there is provided a method of partitioning a recording medium, comprising: (a) storing partition information in a first storage sub-area of the recording medium, wherein the partition information is used for partitioning a storage area included in the recording medium into a number of storage sub-areas; and (b) storing authority information in a second storage sub-area of the recording medium, wherein the authority information indicates whether an access instruction for accessing one of the storage sub-areas has authority to access the storage sub-area.

According to another aspect of the present invention, there is provided a method of accessing a recording medium which stores authority information that indicates whether an access instruction for accessing one of partitioned storage sub-areas has authority to access the partitioned storage sub-area, the method comprising: (a) receiving the access instruction for accessing the partitioned storage sub-area of the recording medium; (b) determining whether the access instruction has the authority to access the partitioned storage sub-area by using the authority information stored in the recording medium; and (c) controlling the recording medium according to the access instruction when the access instruction has the authority to access.

### BRIEF DESCRIPTION OF THE DRAWINGS

The above and other aspects of the present invention will become more apparent by describing in detail exemplary embodiments thereof with reference to the attached drawings in which:

FIG. 1 is a conceptual diagram showing various contents stored in a conventional NAND flash memory;

FIGS. 2a and 2b are conceptual diagrams showing a method of restricting recording authority in a general NAND flash memory;

FIG. 3 is a structural view showing a recording medium and a recording device according to an exemplary embodiment of the present invention;

FIG. 4 is a flowchart of a method of partitioning a storage area of a recording medium according to an exemplary embodiment of the present invention;

FIG. 5 is a flowchart of a method of accessing a recording medium according to an exemplary embodiment of the present invention;

FIG. 6 is a flowchart of a method of accessing a recording medium according to another exemplary embodiment of the present invention; and

FIG. 7 is a view showing a partitioning of a storage area of a NAND flash memory according to an exemplary embodiment of the present invention.

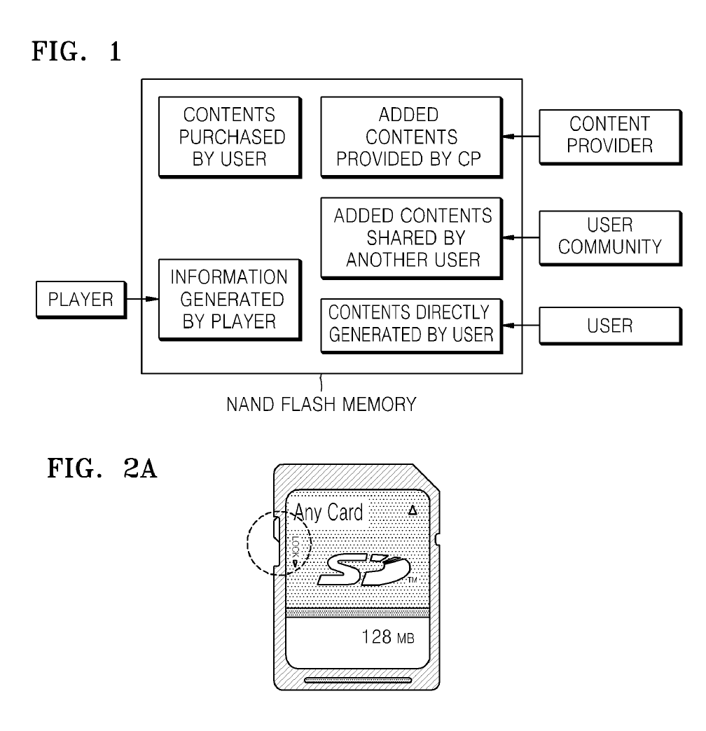

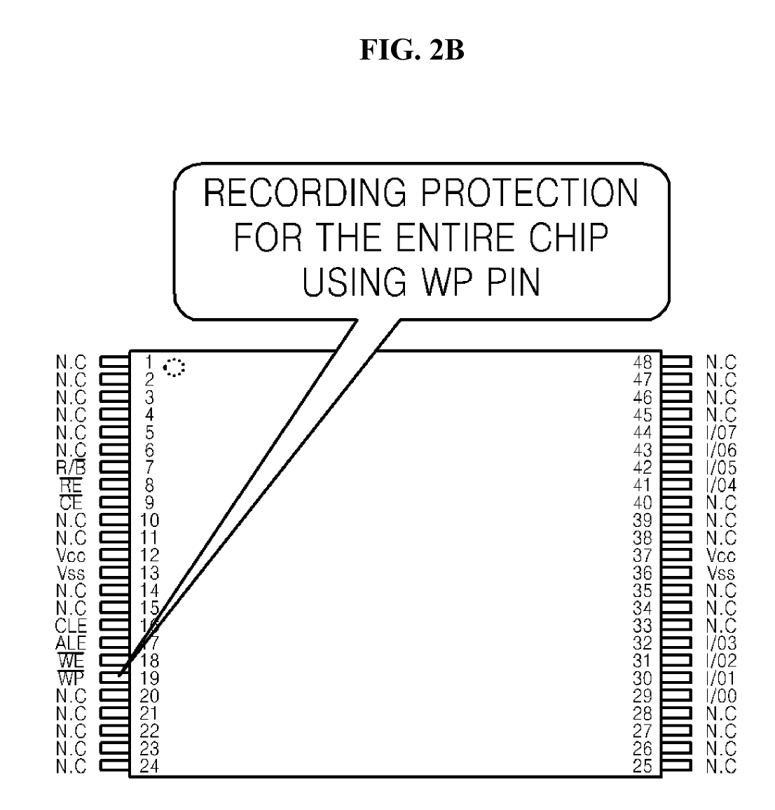

### DETAILED DESCRIPTION OF EXEMPLARY EMBODIMENTS OF THE INVENTION

Hereinafter, exemplary embodiments of the present invention will be described in detail with reference to the attached drawings.

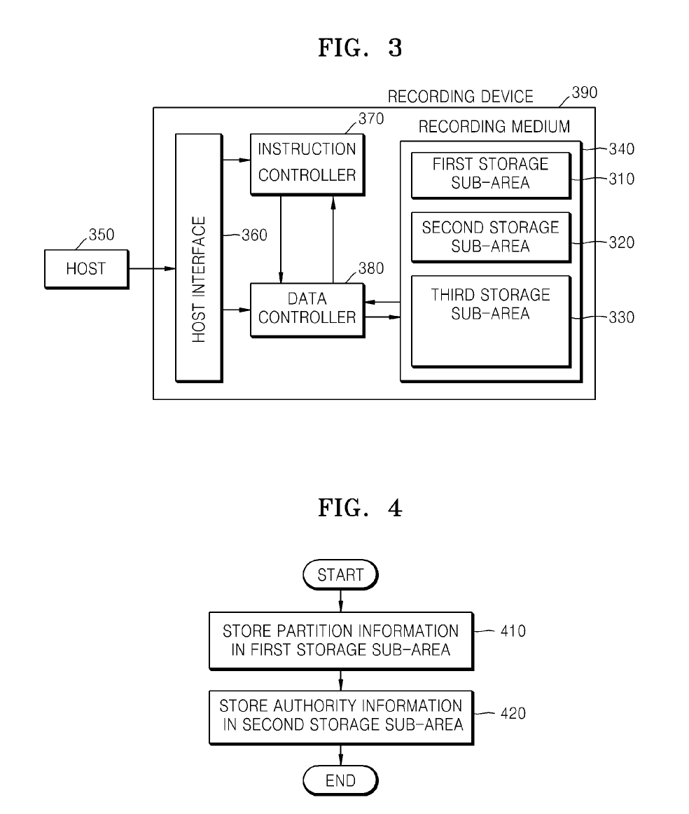

FIG. 3 is a structural view showing a recording medium and a recording device according to an exemplary embodiment of the present invention.

Referring to FIG. 3, the recording medium 340 according to the exemplary embodiment includes a first storage sub-area 310, a second storage sub-area 320, and a third storage sub-area 330. In addition, the recording device 390 according to the exemplary embodiment includes a host 350, a host interface 360, an instruction controller 370, and a data controller 380.

The recording medium 340 is a device in which data is stored, and the recording device 390 is a device which includes the recording medium 340 and records data in the recording medium 340. When the recording medium 340 is a flash memory, the recording device 390 is a flash memory card.

The first storage sub-area 310 is an area in which partition information used to partition a predetermined storage area included in the recording medium 340 into a number of storage sub-areas is stored. The first storage sub-area 310 may correspond to a master boot record (MBR) of the recording medium 340. The partition information includes an entry number representing the number used for partitioning the storage area of the recording medium 340 and physical addresses of the partitioned storage sub-areas. An independent file system may exist in every storage sub-area. The MBR is referred to as an area for starting a system recorded in front of the recording medium 340. For example, 512 bytes may be allocated to the MBR.

The second storage sub-area 320 is an area in which authority information which indicates whether an access instruction for accessing a storage sub-area from among the storage sub-areas partitioned according to the partition information stored in the first storage sub-area 310 has authority to access the storage sub-area. The access instruction may be a recording instruction for recording in the storage sub-area or a deletion instruction for deleting contents in a storage sub-area. The second storage sub-area 320 may be a metadata area used by a flash translation layer (FTL) used as a file system of a flash memory. The metadata area of the FTL may exist in a NAND flash memory. In the metadata area of the FTL, logical sector addresses corresponding to the physical addresses of the partitioned storage sub-areas are stored in a table form. The logical sector addresses have continuous values for the partitioned storage sub-areas. The FTL may be software for allowing the flash memory to be shown as a file allocation table (FAT) disk. In addition, the FTL may be middleware for hiding a deletion operation of the flash memory and disposed between the file system of the host system and the flash memory. In addition, the FTL has a function of converting a logical address generated by the file system in a writing operation to a physical address for an area which executes the deletion operation in advance in the flash memory. The FTL is included in a storage device using the NAND flash memory and may be stored in a memory such as a read-only memory (ROM).

The third storage sub-area 330 is an area in which contents are stored from among the storage sub-areas partitioned according to the partition information stored in the first storage sub-area 310. The third storage sub-area 330 is partitioned into a predetermined number of data storage sub-sub-areas according to the partition information stored in the first storage sub-area 310, the authority information further indicates whether a sub-sub-area access instruction for accessing one of the data storage sub-sub-areas has authority to access the data storage sub-sub-area, and the sub-sub-area access instructions which can access the partitioned data storage sub-sub-areas are allowed authority by the authority information stored in the second storage sub-area 320. When the third storage sub-area is partitioned into three data storage sub-sub-areas, the three data storage sub-sub-areas may be a protected area, a conditional area, and a free area. The protected area is an area in which basic contents purchased by the user are stored and the recording instruction or the deletion instruction from the user is blocked. However, the content provider may access the protected area. The conditional area is an area in which added contents provided by the content provider or added information generated by a content player are stored and the recording instruction or the deletion instruction is allowed only for an authorized apparatus. The free area is an area where all of information that the user wants can be recorded or deleted and a digital content management (DCM) technology can be used. The DCM means an operation or technology for supporting a life cycle in the evolution of digital information.

The host 350 is a device including a device for accessing the recording device 390 through the Internet, a personal computer (PC), or a player for reproducing contents.

The host interface 360 outputs a recording instruction or a deletion instruction received from the host 350 to the instruction controller 370 and outputs data received from the host 350 to the data controller 380.

The instruction controller 370 determines whether the received access instruction has authority to access a storage sub-area to be accessed from among the partitioned storage sub-areas on the basis of the authority information stored in the second storage sub-area 320. According to a result of the determination, when the access instruction has the authority to access, the instruction controller 370 outputs a control signal to the data controller 380. According to the result of the determination, when the access instruction does not have the authority to access, the instruction controller 370 does not output any control signal so that the recording medium is not allowed to be accessed. The instruction controller 370 may be an FTL, and the FTL may be stored in a ROM in the recording device 390.

The data controller 380 receives the control signal from the instruction controller 370, when the received control signal is a first control signal, records the received data in a storage sub-area to be recorded, and when the received control signal is a second control signal, deletes data in a storage sub-area to be deleted. When the recording medium 340 is flash memory, the data controller 380 may be a flash memory controller.

FIG. 4 is a flowchart of a method of partitioning a storage area of a recording medium according to an exemplary embodiment of the present invention. The method of partitioning the storage area of the recording medium according to the exemplary embodiment of the present invention will be described with reference to FIGS. 3 and 4.

In operation 410, the data controller 380 stores partition information used for partitioning the storage area of the recording medium 340, in the first storage sub-area 310 of the recording medium 340. The data controller 380 records the partition information in the first storage sub-area 310 of the recording medium 340 according to control of the instruction controller 370. When the recording medium 340 is the NAND flash memory, the first storage sub-area 340 is an MBR area of the NAND flash memory, and the data controller 380 is a NAND flash memory controller. The partition information includes an entry number which represents the number used for partitioning the NAND flash memory and the physical addresses of the storage sub-areas. An independent file system may exist for every storage sub-area. The MBR is referred to as an area for starting a system recorded in front of the recording device and has a logical sector of 0.

In operation 420, the data controller 380 stores authority information in the second storage sub-area 320 of the recording medium 340. The authority information is information which indicates whether an access instruction for accessing a storage sub-area from among the storage sub-areas partitioned according to the partition information stored in operation 410 has authority to access the storage sub-area. When the recording medium 340 is the NAND flash memory, the second storage sub-area may be a metadata area of the FTL. The metadata area of the FTL exists in the NAND flash memory, and in the metadata area of the FTL, logical sector addresses corresponding to the physical addresses of the storage sub-areas stored in the MBR may be stored in a table form. The logical sector addresses have continuous values for the storage sub-areas. The FTL allows the flash memory to be shown as a FAT disk. The FTL is included in a recording device using the NAND flash memory and may be stored in a memory such as a ROM.

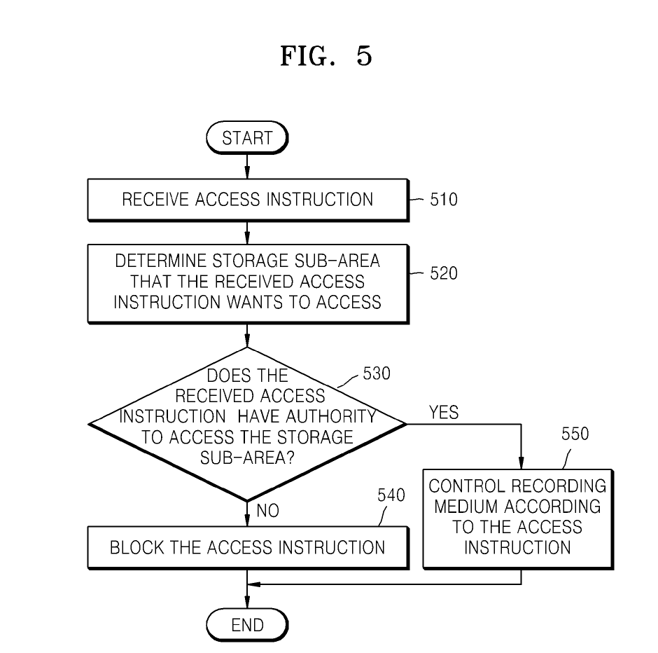

FIG. 5 is a flowchart of a method of accessing a recording medium according to an exemplary embodiment of the present invention. The method of accessing the recording medium according to the exemplary embodiment of the present invention will be described with reference to FIGS. 3 and 5.

In operation 510, the instruction controller 370 receives an access instruction from the host interface 360. When the recording medium 340 is a flash memory, the instruction controller 370 may be an FTL. The access instruction includes a recording instruction for recording in one from among the storage sub-areas of the recording medium 340 and a deletion instruction for deleting contents stored in a storage sub-area from among the storage sub-areas. The FTL may be software stored in an internal memory such as a ROM included in the recording device 390. The recording device 390 may be, for example, a NAND flash memory card.

In operation 520, the instruction controller 370 extracts a logical sector address of the storage sub-area that the access instruction received in operation 510 wants to access, and determines which storage sub-area in the recording medium 340 is to be recorded from the extracted logical sector address by using information stored in the second storage sub-area 320. The storage area of the recording medium may be partitioned into first, second, and third storage sub-areas. In particular, the third storage sub-area may be classified into several data storage sub-sub-areas. For example, the data storage sub-sub-areas may be partitioned into a protected area, a conditional area, and a free area. In the data storage sub-sub-areas, an area for storing contents that a content provider wants to sell is set to the protected area, an area for recording contents additionally provided by the content provider at some time is set to the conditional area, and an area for freely recording by a user is set to the free area. For another example, when a movie download service uses the flash memory, a storage space for recording contents in a download-dedicated apparatus may be set to the conditional area, and a storage space for freely recording by the user may be set to the free area. The protected area is an area in which instructing by a user to record in a flash memory is restricted. The conditional area is an area in which instructing to record in the NAND flash memory when the user uses an authorized apparatus is allowed. The free area is an area in which instructing by all users to record in the NAND flash memory is allowed. It is preferable that sizes and the number of partitioned data storage sub-sub-areas of the flash memory are set according to a use of the content provider.

In operation 530, the instruction controller 370 determines whether the access instruction received in operation 510 has authority to access the storage sub-area determined in operation 520. In order to determine whether the access instruction has the authority, a device which transmits the access instruction is identified. As a method of identifying the device, there is a method of checking the device which transmits the received access instruction through authentication by the instruction controller 370. The authentication may use an existing digital rights management (DRM) technique. The authentication may be performed by using a central processing unit (CPU) identification (ID) number. After the device which transmits the access instruction is identified, it is determined by using the authority information stored in the second storage sub-area 320 whether the identified device has authority to record in the storage sub-area determined in operation 520. According to a result of determination, when the device does not have the authority, operation 540 is performed to block the access instruction, and when the device has the authority to record, an operation 550 is performed to control the recording medium according to the access instruction. The method of determining whether the received access instruction has the authority to access the storage sub-area may include dividing the authority into 4 levels. When the device is determined to be a level 0 device, recording in the free area is allowed. When the device is determined to be in a level 1 device, recording in the free area and the conditional area is allowed. When the device is determined to be in a level 2 device, recording in the free area, the conditional area, and the protected area is allowed. When the device is determined to be in a level 3 device, recording in all areas including the first and second storage sub-areas is allowed. The device corresponding to level 0 is not limited, and the device corresponding to level 1 may be limited to a particular player or a particular device designated by the content provider. The device corresponding to level 2 may be limited to a device used by the content provider. The device corresponding to level 3 may also be limited to a device used by the content provider but is different from the device corresponding to level 2 in that the device corresponding to level 3 can change the partition information and the authority information for accessing the first and second storage sub-areas and partitioning the storage area of the flash memory.

In operation 540, according to a result of determination in operation 530, when the access instruction received in operation 510 does not have the authority to access the storage sub-area determined in operation 520, the instruction controller 370 blocks the access instruction. In order to block the access instruction, the instruction controller 370 that receives the access instruction may not transmit any control signal to the data controller 380 that receives data to be recorded.

In operation 550, according to the result of the determination in operation 530, when the access instruction received in operation 510 has the authority to access the storage sub-area determined in operation 520, the data controller 380 records the received data in a storage sub-area that has the authority to access or delete contents recorded in the storage sub-area, according to a control signal transmitted from the instruction controller 370.

For example, when the logical sector address extracted in operation 520 belongs to one of the first storage sub-area 310, the protected area, and the conditional area, after it is determined that the device that transmits the recording instruction has authority to record in the sub-area or the areas, only a device having the access authority is allowed to be accessed. However, when the logical sector address obtained in operation 520 belongs to the free area, the device that transmits the access instruction does not need to be determined to have the authority and can be accessed according to the access instruction.

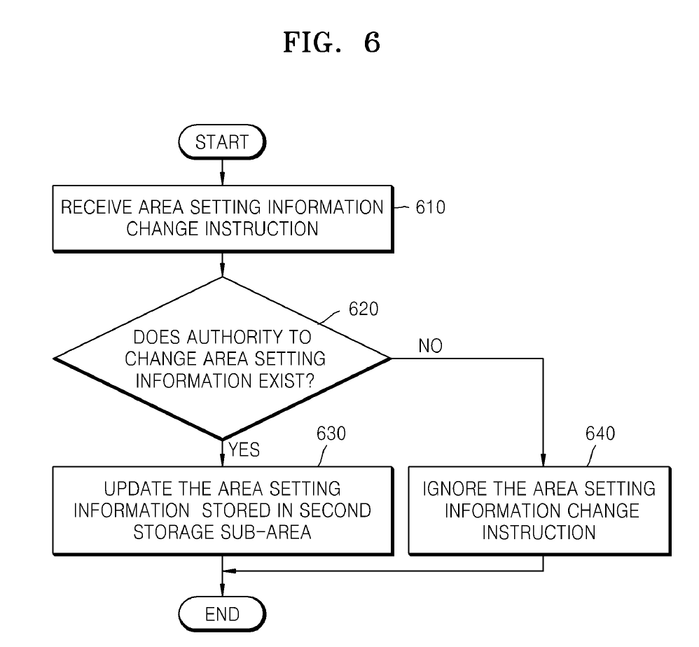

FIG. 6 is a flowchart of a method of accessing a recording medium according to another exemplary embodiment of the present invention. The method of accessing the recording medium according to the exemplary embodiment of the present will be described in detail with reference to FIGS. 3 to 6.

In operation 610, the instruction controller 370 receives an area setting information change instruction from the host interface 360. An area setting information change instruction for changing area setting information may be added to a protocol between the recording device 390 and the host 350 according to the exemplary embodiment of the present invention. A parameter of the area setting information change instruction includes a partition number and an area type. The area type includes the protected area, the conditional area, and the free area. The area setting information is information including that the third storage sub-area 330 of the recording medium 340 is partitioned into how many storage sub-sub-areas and what an area type of the partitioned storage sub-sub-areas is. The area setting information may exist in the second storage sub-area 320. The device corresponding to level 3 which allows all areas including the first storage sub-area to be recorded may change the area setting information stored in the second storage sub-area 320.

In operation 620, the instruction controller 370 determines whether the area setting information change instruction received in operation 610 has authority to change the area setting information. The device which transmits the area setting information change instruction is identified through authentication, so that whether the area setting information change instruction has the authority to change the area setting information can be determined. When the device identified through authentication corresponds to level 3, it is preferable that the area setting information can be changed.

In operation 630, according to a result of determination in operation 620, when the received area setting information change instruction has the authority to change the area setting information, the instruction controller 370 outputs a control signal to the data controller 380, and the data controller 380 which receives the control signal updates area setting information recorded in the second storage sub-area 320.

In operation 640, according to the result of the determination, when the received area setting information change instruction does not have the authority to change the area setting information, the instruction controller 370 ignores the area setting information change instruction.

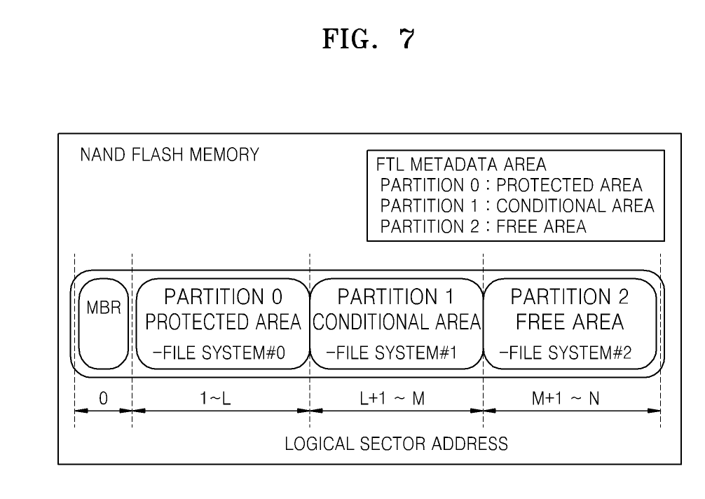

FIG. 7 is a view showing an exemplary embodiment of partitioning a storage area of a NAND flash memory according to an exemplary embodiment of the present invention.

Referring to FIG. 7, from among storage sub-areas of the NAND flash memory, a partition 0 may be set to a protected area, a partition 1 may be set to a conditional area, and a partition 2 may be set to a free area. In addition, an MBR area and an FTL metadata area exist in the NAND flash memory.

The protected area is an area in which a recording instruction of a user is blocked and is operated by a file system #0. Logical sector addresses of the protected area are allocated continuously from 1 to L. The protected area is an area in which basic contents that the content provider sells are stored and deleting or recording by a user need to be restricted.

The conditional area is an area in which a recording instruction is allowed only for an authenticated device and is operated by a file system #1. Logical sector addresses of the conditional area are allocated to from L+1 to M, and the allocated addresses are continuous. The conditional area may be an area for storing added contents provided by the content provider and information generated by a player. The information generated by the player may be, for example, a bookmark.

The free area is an area in which the recording instruction is allowed for all devices and is operated by a file system #2. Logical sector addresses of the free area are allocated to from M+1 to N and the allocated addresses are continuous. The free area can record all of information that anyone wants. The file systems #0 to #2 are independent file systems from each other and may be the same or different from each other.

The MBR area is a system starting area and is an area in which physical addresses of the partitions 0 to 2 are recorded. The logical sector address of the MBR area is allocated to 0, and generally, is allocated with 512 bytes.

The FTL metadata area is an area disposed in the NAND flash memory and controlled by the FTL. In the FTL metadata area, a logical sector address used for accessing by the user does not exist, so that the FTL metadata area can be prevented from cracking by the user. The FTL metadata area may store a table which represents correspondence relations between physical addresses and logical sector addresses and authority information on authorities to access areas partitioned by the partition information.

Accordingly, contents provided by the content provider are prevented from being deleted by carelessness of a user or external factors, and an area of a flash memory can be partitioned to be used for various purposes. In addition, the partitioned sub-areas or sub-sub-areas correspond to access authority levels, so that graduated access authorities can be provided according to users. For example, a PC of a general user and players (televisions, set-top boxes, and portable media players) authenticated by the content provider may be provided with graduated access authorities. In order to provide additional contents after distributing contents, the content provider can provide the additional contents only to authenticated players and may allocate an area to store the additional contents in the flash memory.

In addition, there are advantages in that, on the user's point, a ROM area and a random access memory (RAM) area are simultaneously provided to the flash memory. On the content provider's point, desired contents are prevented from being deleted, and an additional space for storing added contents can be guaranteed.

The FTL for performing the method of restricting accessing of the flash memory is disposed in a storage device using the flash memory, so that access of a host is difficult, and it is more safe against cracking as compared with the file system.

The exemplary embodiments of the present invention can be written as computer programs and can be implemented in general-use digital computers that execute the programs using a computer readable recording medium. In addition, a structure of data used in the exemplary embodiments of the present invention can be recorded in the computer readable recording medium through various means. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A recording medium comprising:
a storage area including a number of storage sub-areas;
a first storage sub-area of the storage area, which stores partition information used for partitioning the storage area into the number of storage sub-areas;
a second storage sub-area of the storage area, which stores authority information which indicates whether a sub-area access instruction for accessing one of the storage sub-areas has the authority to access the storage sub-area; and
a third storage sub-area of the storage area, which stores contents.

2. The recording medium of claim 1, wherein the third storage sub-area includes a number of data storage sub-sub-areas;
wherein the partition information is further used for partitioning the storage sub-area into the number of data storage sub-sub-areas;
wherein the third storage sub-area is partitioned into the number of data storage sub-sub-areas according to the partition information;
wherein the authority information further indicates whether a sub-sub-area access instruction for accessing one of the data storage sub-sub-areas has authority to access the data storage sub-sub-area; and
wherein sub-sub-area access instructions which can access the data storage sub-sub-areas receive authority from the authority information.

3. The recording medium of claim 1, wherein the second storage sub-area further comprises a logical sector address corresponding to a physical address of each of the storage sub-areas partitioned according to the partition information.

4. The recording medium of claim 1, wherein the partition information comprises an entry number which represents the number of storage sub-areas resulting from the partition of the storage area and physical addresses of the partitioned storage sub-areas.

5. The recording medium of claim 1,
wherein the recording medium is a flash memory, and
wherein the second storage sub-area is a metadata area used by a flash translation layer used as a file system of the flash memory.

6. The recording medium of claim 1, wherein the sub-area access instruction includes a recording instruction for recording in one of the storage sub-areas and a deletion instruction for deleting data in one of the storage sub-areas.

7. The recording medium of claim 2, wherein the sub-sub-area access instruction includes a recording instruction for recording in one of the data storage sub-sub-areas and a deletion instruction for deleting data in one of the data storage sub-sub-areas.

8. A recording device comprising:
a recording medium which stores authority information which indicates whether an access instruction for accessing a partitioned storage sub-area has authority to access the partitioned storage sub-area;
an instruction controller which determines whether the access instruction has authority to access the partitioned storage sub-area on the basis of the authority information stored in the recording medium and outputs a control signal if the access instruction has the authority to access according to a result of the determination; and
a data controller which controls the recording medium upon receiving the control signal from the instruction controller.

9. The recording device of claim 8,
wherein the access instruction includes a recording instruction for recording in the partitioned storage sub-area;
wherein the control signal includes a first control signal; and
wherein the data controller records received data to the partitioned storage sub-area upon receiving the first control signal.

10. The recording device of claim 8,
wherein the access instruction includes a deletion instruction for deleting data stored in the partitioned storage sub-area;
wherein the control signal includes a second control signal; and
wherein the data controller deletes data stored in the partitioned storage sub-area upon receiving the second control signal.

11. A method of partitioning a recording medium, comprising:
storing partition information in a first storage sub-area of the recording medium, wherein the partition information is used for partitioning a storage area included in the recording medium into a number of storage sub-areas; and
storing authority information in a second storage sub-area of the recording medium, wherein the authority information indicates whether an access instruction for accessing one of the storage sub-areas has authority to access the storage sub-area.

12. The method of claim 11, further comprising partitioning a remaining storage area of the storage area excluding the first and second storage sub-areas into a number of data storage sub-sub-areas according to the partition information and storing instructions that can access the data storage sub-sub-areas in the second storage sub-area.

13. The method of claim 11, wherein the first storage sub-area is a Master Boot Record area which is a first sector of the recording medium.

14. The method of claim 11, wherein the second storage sub-area comprises a logical sector address corresponding to a physical address of each of the storage sub-areas partitioned according to the partition information.

15. The method of claim 11, wherein the partition information comprises an entry number which represents the number of storage sub-areas resulting from the partitioning of the storage area and physical addresses of the storage sub-areas.

16. The method of claim 10, wherein the access instruction includes a recording instruction for recording in one of the storage sub-areas or a deletion instruction for deleting data in one of the storage sub-areas.

17. The method of claim 11, wherein the access instruction includes a recording instruction for recording in one of the data storage sub-sub-areas and a deletion instruction for deleting data in one of the data storage sub-sub-areas.

18. A method of accessing a recording medium which stores authority information that indicates whether an access instruction for accessing one of partitioned storage sub-areas has authority to access the partitioned storage sub-area, the method comprising:
receiving the access instruction for accessing the partitioned storage sub-area of the recording medium;
determining whether the access instruction has the authority to access the partitioned storage sub-area by using the authority information stored in the recording medium; and
controlling the recording medium according to the access instruction if the access instruction has the authority to access.

19. The method of claim 18,
wherein the access instruction includes a recording instruction for recording in the partitioned storage sub-area, and
wherein in the controlling the recording medium, if the recording instruction has the authority to record, data corresponding to the recording instruction is recorded in the partitioned storage sub-area.

20. The method of claim 18,
wherein the access instruction includes a deletion instruction for deleting data stored in the partitioned storage sub-area, and
wherein in the controlling the recording medium, if the deletion instruction has the authority to delete, data stored in the storage sub-area is deleted.
